(19) United States
(12) Patent Application Publication
(10) Pub. No.: US 2014/0287518 A1
(43) Pub. Date: Sep. 25, 2014

(54) METHOD OF CONCENTRATION DETERMINATION AND GAS CONCENTRATION SENSOR

(71) Applicant: SICK AG, Waldkirch/Breisgau (DE)

(72) Inventors: Jacques DEPOUTOT, Hannover (DE); Markus FACKLER, Hamburg (DE); Laila FORNELLI, Lubeck (DE); Iris SIEMESGELUSS, Norderstedt (DE); Ingo REINKE, Eberstorf (DE); Norbert ROTHKAMP, Hamburg (DE)

(73) Assignee: SICK AG, Waldkirch/Breisgau (DE)

(21) Appl. No.: 14/219,462

(22) Filed: Mar. 19, 2014

(30) Foreign Application Priority Data
Mar. 22, 2013 (DE) 10 2013 205 139.5

(51) Int. Cl. G01N 27/62

(52) U.S. Cl. CPC G01N 27/626
USPC 436/143; 422/54; 436/154

(57) ABSTRACT

The invention relates to a method for determining a concentration of at least one component of gas present in a gas line or in a gas container, wherein gas is led off from the gas line or the gas container at a measurement location and is supplied to at least one gas flame; the ion flow is measured between a gas flame to which gas is supplied and an electrode arrangement; the temperature of a gas flame is measured to which gas is supplied; and the concentration of the at least one component of the gas present in the gas line or in the gas container is determined from the measurement ion flow and the measured temperature or from values related thereto. The invention furthermore relates to gas concentration sensors for carrying out the method in accordance with the invention.

The invention relates to a method of determining a concentration of at least one component of gas present in a gas line or in a gas container and to a gas concentration sensor.

It is in particular important for flammable substances to be able to determine their concentration, for example in air, as exactly as possible.

This is in particular also of great importance in safety applications. A lower flammable limit (LFL) and a lower explosive limit (LEL) have, for example, been fixed for every one of such substances beneath which limits a mixture of the substance and air is too lean to maintain combustion. On the other hand, there is also a specific concentration for every flammable substance above which a mixture is too rich to combust (upper flammable limit, UFL, or upper explosive limit, UEL).

Between the lower explosive limit and the upper explosive limit there is a dangerous concentration range in which there is a risk of explosion or a risk of flammability.

For safety reasons, the concentration of flammable substances in most applications may not lie too close to the range between the lower and upper explosion limits.

In a number of applications, hydrocarbons are present as flammable substances.

Various sensors are used for determining the concentration of flammable substances in gases, for example in air. There are, for example, catalytic sensors or infrared absorption sensors.

A method of the prior art, for example, uses a flame ionization detector (FID). In this respect, for example, a sample gas is extracted from a measurement volume. This measurement volume can be a gas container or also a gas line. A small quantity of this sample gas is, for example, mixed with hydrogen fuel and is supplied to a gas burner and is combusted there. The flammable substances within the hydrogen flame generate ions which can be measured, for example, using a correspondingly sensitive ammeter. The corresponding electrical signal is a measure for the quantity of hydrocarbons present.

FID measurements are characterized by an advantageously short response time (e.g. less than 1.5 seconds). However, the measurement of the concentration is indirect and suffers from wide scattering so that the safety range about the above-described hazardous flammability range has to be selected as large. This can have the result that a monitored process is stopped too soon or too frequently and thus becomes uneconomic.

FID processes are described, for example, in U.S. Pat. No. 3,767,363 A and U.S. Pat. No. 7,704,748 B2. A gas concentration sensor having the features of the preamble of claim 9 is known from US 2003/0085714 A1.

Another method of concentration determination measures the temperature of a flame which is exposed to the gas having flammable substances (flame temperature analysis, FTA).

In this respect, known methods measure the heat which is output by a pilot flame which burns in a measurement chamber. The gas to be examined can be branched off from a gas container or from a gas line and can be supplied directly to this measurement chamber, for example. This gas additionally feeds the pilot flame and thus effects a temperature increase. The flame temperature can be measured using a temperature sensor which is arranged directly above the flame, for example.

The gas concentration can be precisely determined using a flame temperature measurement. However, a flame temperature measurement has a longer response time and a more limited measurement range.

Flame temperature analyzers are described, for example, in U.S. Pat. No. 5,053,200 A and U.S. Pat. No. 7,704,748 B2.

It is the object of the present invention to provide a method of determining a concentration of at least one component of gas present in a gas line or in a gas container and to provide a gas concentration sensor with which method and sensor the concentration of in particular hydrocarbons in gas mixtures can be determined fast, precisely and reliably.

This object is satisfied by a method having the features of claim 1 and by gas concentration sensors having the features of claim 9 or 15. Dependent claims are directed to special embodiments.

In the method in accordance with the invention, gas is led off from the gas line or the gas container at a measurement location and is supplied to at least one gas flame. The ion flow between this gas flame and an electrode arrangement is measured in a similar manner to an FID measurement.

In addition, similar to an FTA measurement, the temperature of a gas flame is measured to which gas from the gas line or from the gas container is supplied. In the method in accordance with the invention, the gas which is used for measuring the ion flow and the gas which is used for measuring the flame temperature are led off at the same measurement location of the gas line or of the gas container. In this respect, the “leading off at the same measurement location” means that the gas outlet for the gas flame for measuring the ion flow and that for the flame for measuring the temperature take place at least so adjacent to the gas line or to the gas container that the concentration of the flammable substance in the gas can be assumed to be the same at the outlet points, preferably in that the gas is branched off from the gas line or from the gas container at the same location.

Using the measured ion flow and the measured temperature, the concentration of the at least one flammable component of the gas present in the gas line or in the gas container is then determined by an evaluation unit.

The method in accordance with the invention can in particular be used for determining the concentration of hydrocarbons in a gas, e.g. air, to ensure that a concentration is always present which lies outside the above-described hazardous range between the lower and upper explosion limits.

The invention therefore goes beyond a simple doubling of a measurement in accordance with one principle. It is ensured that a fast response time is present due to the evaluation of the measured ion flow. On the other hand, the evaluation of the flame temperature ensures a precise measurement.

It is generally possible that two separate gas flames are used, with the ion flow being measured at the one and the flame temperature being measured at the other, with the flames being fed with gas led off at the same measurement point and with the ion flow signal and the temperature signal being evaluated by the evaluation unit. It is, however, preferred, for the ion flow and the flame temperature to be determined at one and the same gas flame because it is then ensured in a manner which is as ideal as possible that both measurements are made at a gas flame which is fed with gas of the concentration exactly to be determined.

It can be of particular advantage if additional fuel, for example hydrogen, is supplied to the gas flame. This ensures a constant combustion, with the supplied gas whose concentration of flammable substances is to be determined being ionized in the flame to measure the ion flow or contributing to the increase in the flame temperature due to the additional combustion.

For safety reasons and to provide a defined measurement atmosphere, the gas burner and thus the gas flame are advantageously arranged in a combustion chamber.

It is additionally possible with such a combustion chamber that the measurement gas which is branched off from the gas line or from the gas container for the purpose of the concentration determination is also at least supplied to the gas flame from its outer side in that it is not directly introduced into the gas burner, but rather into the surrounding combustion chamber. This can in particular be advantageous in the flame temperature measurement in which the measurement gas present in the atmosphere of the combustion chamber produces the measurable temperature increase.

On the other hand, it can also be advantageous for the measurement gas to be supplied to the gas flame together with a fuel, e.g. hydrogen, by the gas burner. This can be advantageous in the measurement of the ion flow since there the substances forming the ions are introduced directly into the flame with the fuel.

The measurement supply alternatively advantageously to be used can be selected according to the respectively present conditions, demands and gas compositions. Correspondingly set combinations of these gas supply alternatives can also be provided.

Independent claims 9 and 15 relate to gas concentration sensors in accordance with the invention with which the method in accordance with the invention can be carried out. For this purpose, a gas concentration sensor in accordance with the invention has a gas burner for producing a gas flame.

A gas line connects the gas burner in accordance with claim 9 to a measurement location which is present at a gas line or at a gas container for which the concentration of the hazardous component in the gas located therein is to be determined. In addition, the gas concentration sensor in accordance with the invention has a current measurement device to which an electrode arrangement is connected which is arranged and is connected to the current measurement device such that an ion flow between the flame and the electrode arrangement can be measured with it. An evaluation device which is connected to the current measurement device serves for the determination of the concentration of the hazardous component, in particular of hydrocarbons, for example, in the gas while using the signal of the current measurement device. A temperature sensor is arranged such that the temperature of this gas flame can be measured by it.

In an embodiment of claim 15, the measurement location is connected to the combustion chamber via a measurement gas line to be able to supply the measurement gas from the outside to the gas flame which is arranged in a combustion chamber for this purpose.

Advantages and special embodiments of these gas concentration sensors in accordance with the invention results in an analog manner from the above-described special embodiments and advantages of the method in accordance with the invention.

A branch line can be provided at the measurement gas line with the gas concentration sensors in accordance with the invention. In an embodiment in which the measurement gas is supplied to the burner, an additional branch line can e.g. be provided which can also conduct measurement gas into a combustion chamber arranged around the gas flame.

On the other hand, in an embodiment in which measurement gas is anyway supplied into a combustion chamber around the gas flame, a branch line can be provided in the direction of the gas burner.

It is possible with these special embodiments to set or change the division of the measurement gas between the burner and the combustion chamber surrounding the gas flame. Corresponding valves can be provided in the supply lines for this purpose.

It is thus possible to carry out an advantageous division of the measurement gas between the combustion chamber and the direct supply to the burner in dependence on the demands and the gas components to be measured and/or only to select one of these alternatives.

The evaluation device of the gas concentration sensors in accordance with the invention is not only connected to the current measurement device, but also to the temperature sensor and is configured such that it additionally uses the signal of the temperature sensor for determining the concentration of the at least one hazardous component in the gas.

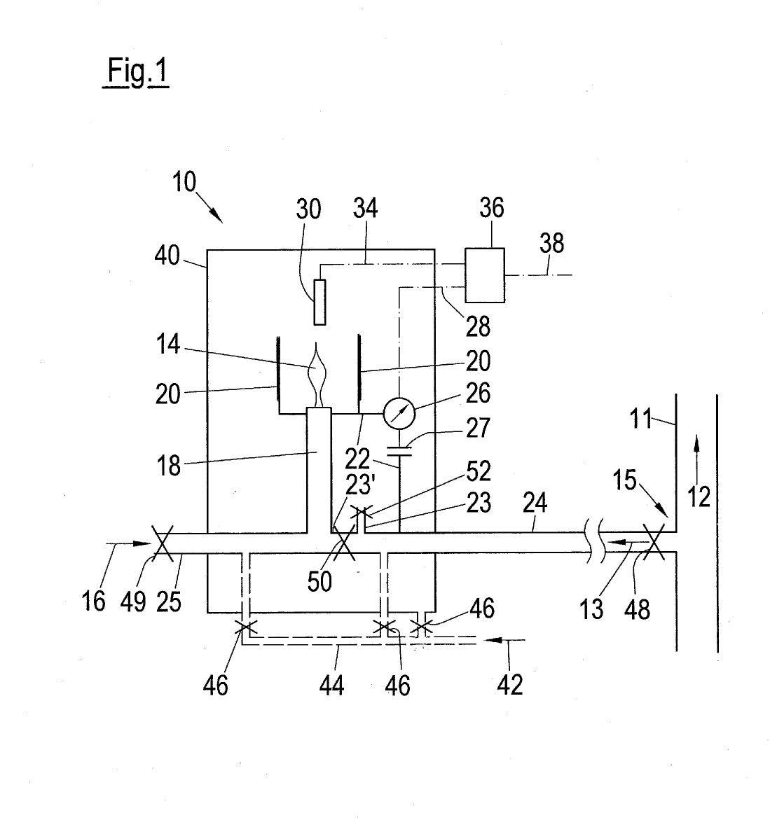

The invention will be explained in detail with reference to the enclosed schematic FIG. 1.

FIG. 1 shows in a schematic representation an embodiment of a gas concentration sensor in accordance with the invention.

In FIG. 1, 10 designates a sensor arrangement for determining the concentration of flammable substances in a gas 12 which flows in a gas line 11 in the direction of the arrow in this example. Some of the gas 12 is branched off as a measurement gas 13 through a measurement gas line 24 from the gas line 11 at a measurement location 15.

Additional fuel 16, for example, hydrogen, is supplied through a further feed 25 in the shown example. A flame 14 is fed with this fuel and/or with the measurement gas 13 by a gas burner 18.

The measurement gas flow 13 and the supply of the fuel 16 can be set or blocked with the aid of the valves 48 and 49 which can, for example, be configured as metering valves.

In the embodiment shown, this arrangement is received in a combustion chamber 40.

In the embodiment shown, the measurement gas line 24 splits at its end into two branch lines 23, 23′ which can be metered or closed by valves 50 and 52 respectively. Whereas the branch line 23 allows a connection between the measurement gas line 24 and the interior of the combustion chamber 40 with an open valve 52, the branch line 23′ leads from the branch line 23′ from the measurement gas line 24 to the gas burner 18 with an open valve 50.

The gas flow of the measurement gas 13 to the flame 14 can be controlled with the aid of the valves 50 and 52 respectively (or with the aid of a three-way valve combining their functions). The measurement gas is either supplied directly to the fuel 16 with an open valve 50 and a closed valve 52 in order in this manner to move through the burner 18 to the flame 14 or it is let into the combustion chamber 40 with a closed valve 50 and an open valve 52 to feed the flame 14 with measurement gas 13 from the outside. These supply alternatives can also be combined in dependence on the demands and on the gas to be examined.

In corresponding applications, on the other hand, provision can also be made that the measurement gas line 24 only leads to the burner 18 or only to the combustion chamber 40. An embodiment with valves provides a greater flexibility here, however.

Differing from the shown embodiment, provision can also be made that two separate measurement gas lines lead into the combustion chamber 40 or to the gas burner 18 which are branched off separately at the gas line 11. In this respect, the branch points should, however, be arranged in an advantageous manner such that the concentrations of the respective branched off gas are the same to obtain defined measurement conditions in the flame 14.

The flammable substances, in the example described that is the hydrocarbons, in the measurement gas are ionized in the flame 14. An electrode arrangement 20 is provided around the flame 14 and leads off produced ions through contact lines 22 and an ammeter 26 with respect to ground; here, for example, the metal measurement gas line 24. For this purpose, a voltage source 27 can be provided in a manner known per se between the electrodes 20 and the measurement gas line 24 to maintain the ion flow.

The ammeter 26 is connected to an evaluation unit 36 via a signal line 28.

A temperature sensor, for example a thermal element 30, is provided above the flame 14. This thermal element is likewise connected to the evaluation unit 36 via a signal line 34 and is arranged such that it can determine the temperature of the flame 14 or a measured value related thereto.

The evaluation unit 36 is configured such that it determines an output value which represents a measure for the concentration of flammable substances in the gas 12 from the signals of the ammeter 26 and of the thermal element 30 obtained via the signal lines 28 and 34. This value or a corresponding signal are output via the output line 38 of the evaluation unit 36 in order, for example, to be forwarded to a display unit, to trigger a warning signal or to stop a process when the concentration of the flammable substances lies in the above-described hazardous range between the lower and upper explosion limits.

In the embodiment of FIG. 1, supply lines 44 are optionally provided with which compressed air 42 can, for example, be supplied to the process in a controlled manner with the aid of the valves 46, with the compressed air being able to be fed either directly into the combustion chamber 40, into the measurement gas supply line 24 or into the hydrogen supply line 25. Whether and to what degree additional compressed air can be supplied can be fixed with reference to the specific measurement conditions, in particular with reference to the gases or gas quantities and gas compositions to be examined.

The described application provides that the gas concentration sensor in accordance with the invention is connected via the measurement gas line 24 to a gas line through which gas flows to a process, with the gas composition supplied to this process having to be examined for its content of flammable substances, for example hydrocarbons, so that the process can run in a controlled manner. A gas concentration sensor in accordance with the invention can, on the other hand, also be connected via the measurement gas line 24 to a gas container which contains a gas whose concentration of flammable substances, for example hydrocarbons, has to be monitored.

### REFERENCE NUMERAL LIST

10 sensor
11 gas line
12 gas
13 measurement gas
14 gas flame
15 measurement point
16 fuel
18 gas burner
20 electrode arrangement
22 contact line
23, 23′ branch line
24 measurement gas line
25 fuel line
26 ammeter
27 voltage source
28 signal line
30 thermal element
34 signal line
36 evaluation unit
38 output line
40 combustion chamber
42 compressed air
44 compressed air line
46 valve
48, 49 valve
50, 52 valve

1. A method of determining a concentration of at least one component of gas (12) present in a gas line (11) or in a gas container, the method comprising the steps of:
leading off gas (13) at a measurement location (15) from the gas line (11) or from the gas container and supplying the gas to at least one gas flame (14);
measuring an ion flow between a gas flame (14) and an electrode arrangement (20), wherein gas (13) is supplied to the gas flame from the measurement location (15);
measuring the temperature of a gas flame (14) to which gas (13) is supplied from the measurement location (15); and
determining the concentration of the at least one component of the gas (12) present in the gas line (11) or in the gas container the measured ion flow and from the measured temperature.

2. The method in accordance with claim 1, wherein the gas flame whose ion flow is measured, with the flow being measured between the gas flame and the electrode arrangement (20), and the gas flame whose temperature is measured is the same gas flame (14).

3. The method in accordance with claim 2, further comprising the step of supplying additional fuel (16) to the gas flame (14).

4. The method in accordance with claim 3, wherein the additional fuel (16) is hydrogen.

5. The method in accordance with claim 2, wherein the gas flame (14) is arranged in a combustion chamber (40).

6. The method in accordance with claim 3, further comprising the step of supplying the gas (12) to the gas flame (14) which is arranged in a combustion chamber and wherein the gas (12) is supplied at least also from its outer side in that it is introduced into the combustion chamber (40).

7. The method in accordance with claim 3, wherein the gas (12) is at least also supplied to the gas flame (14) together with the fuel (16).

8. The method in accordance with claim 1, wherein the at least one component is formed by hydrocarbons contained in the gas (12).

9. A gas concentration sensor (10), connected to a measurement location (15) at a gas line (11) or at a gas container for measuring a concentration of at least one component of gas (12) present in the gas line (11) or in the gas container, comprising
a gas burner (18) for generating a gas flame (14);
a measurement gas line (24) for connecting the gas burner (18) to the measurement location (15);
a current measurement device (26);
an electrode arrangement (20) which is connected to the current measurement device (26) and which is arranged and is connected to the current measurement device (26) such that an ion flow between the gas flame (14) and the electrode arrangement (20) can be measured using the current measurement device (26); and
an evaluation device (36) connected to the current measurement device (26) for determining the concentration of at least one component in the gas (12) using the signal of the current measurement device (26),
further comprising
a temperature sensor (30) which is arranged such that the temperature of the gas flame (14) can be measured with it; and
wherein the evaluation device (36) is connected to the temperature sensor (30) and is configured such that it additionally uses the signal of the temperature sensor (30) for determining the concentration of the at least one component in the gas (12).

10. The gas concentration sensor in accordance with claim 9, wherein the at least one component comprises hydrocarbons.

11. The gas concentration sensor in accordance with claim 9, wherein a supply device (25) is connected to the gas burner (18) for supplying fuel (16).

12. The gas concentration sensor in accordance with claim 11, wherein the fuel comprises hydrogen.

13. The gas concentration sensor in accordance with claim 9, wherein the gas burner (18) is arranged in a combustion chamber (40) and the measurement gas line (24) has a branch line (23) which leads into the combustion chamber (40).

14. The gas concentration sensor in accordance with claim 13, wherein one or more valves (50, 52) with which the measurement gas flow flowing through the measurement gas line (24) between the gas burner (18) and the combustion chamber (40) can be set or changed.

15. A gas concentration sensor (10), connected to a measurement location (15) at a gas line (11) or at a gas container for measuring a concentration of at least one component of gas (12) present in the gas line (11) or in the gas container, comprising
a gas burner (18) in a combustion chamber (40) for generating a gas flame (14);
a measurement gas line (24) for connecting the combustion chamber (40) to the measurement location (15);
a supply device (25) connected to the gas burner (18) for supplying fuel (16);
a current measurement device (26);
an electrode arrangement (20) which is connected to the current measurement device (26) and which is arranged and is connected to the current measurement device (26) such that an ion flow between the gas flame (14) and the electrode arrangement (20) can be measured using the current measurement device (26); and
an evaluation device (36) connected to the current measurement device (26) for determining the concentration of at least one component in the gas (12) using the signal of the current measurement device (26),
further comprising a temperature sensor (30) which is arranged such that the temperature of the gas flame (14) can be measured with it; and
wherein the evaluation device (36) is connected to the temperature sensor (30) and is configured such that it additionally uses the signal of the temperature sensor (30) for determining the concentration of the at least one component in the gas (12).

16. The gas concentration sensor in accordance with claim 15, wherein the fuel comprises hydrogen.

17. The gas concentration sensor in accordance with claim 15, wherein the at least one component comprises hydrocarbons.

18. The gas concentration sensor in accordance with claim 15, wherein the measurement gas line (24) has a branch line (23′) which leads to the gas burner (18).

19. The gas concentration sensor in accordance with claim 15, wherein one or more valves (50, 52) with which the measurement gas flow flowing through the measurement gas line (24) between the gas burner (18) and the combustion chamber (40) can be set or changed.
